(19) United States
(12) Patent Application Publication
(10) Pub. No.: US 2025/0164656 A1
(43) Pub. Date: May 22, 2025

(54) TRANSFER LEARNING FOR ML-ASSISTED SEISMIC INTERPRETATION

(71) Applicant: Schlumberger Technology Corporation, Sugar Land, TX (US)

(72) Inventors: Adam Niven Shumaker, Houston, TX (US); Arvind Sharma, Houston, TX (US)

(21) Appl. No.: 18/832,534

(22) PCT Filed: Jun. 23, 2023
(86) PCT No.: PCT/US2023/068976

§ 371 Date: Jul. 24, 2024

Related U.S. Application Data
(60) Provisional application No. 63/366,882, filed on Jun. 23, 2022.

(51) Int. Cl. G01V 1/28

(52) U.S. Cl. CPC G01V 1/282; G01V 2210/614; G01V 2210/673

(57) ABSTRACT

A method includes receiving field seismic data that represents a subsurface, identifying features in the field seismic data using a machine learning model that was trained using at least one first synthetic seismic data set that includes one or more features and one or more labels of the features, and at least one second synthetic seismic data set, the first and second synthetic seismic data sets both generated based on a geological model. Noise is injected into the second synthetic seismic data based on the geological model. The method also includes generating a model of the subsurface based at least in part on the features that were identified in the field seismic data using the machine learning model.

### CROSS-REFERENCE TO RELATED APPLICATIONS

This application claims priority to U.S. Provisional Application having Ser. No. 63/366,882, which was filed on Jun. 23, 2022 and is incorporated herein by reference in its entirety.

### BACKGROUND

Subsurface mapping and characterization generally includes processing seismic data, which historically has been a time-consuming and subjective process. Recently, machine learning (ML) methods have been implemented to facilitate the seismic interpretation. ML-assisted seismic interpretation is a supervised process in which an expert (human) seismic image interpreter trains a machine model to predict geological features like faults and stratigraphy. A trained machine model uses image classification and statistical methods to output a predicted geological interpretation and the respective likelihood of that prediction. Existing ML-assisted seismic interpretation methods can produce inaccurate predictions in the presence of geophysical artifacts such as illumination shadows and “migration smiles” and converted mode energy.

### SUMMARY

Embodiments of the disclosure include a method that includes receiving field seismic data that represents a subsurface, identifying features in the field seismic data using a machine learning model that was trained using at least one first synthetic seismic data set that includes one or more features and one or more labels of the features, and at least one second synthetic seismic data set, the first and second synthetic seismic data sets both generated based on a geological model. Noise is injected into the second synthetic data based on the geological model. The method also includes generating a model of the subsurface based at least in part on the features that were identified in the field seismic data using the machine learning model.

Embodiments of the disclosure also include a computing system that includes one or more processors, and a memory including one or more non-transitory, computer-readable media storing instructions that, when executed by at least one of the one or more processors, cause the computing system to perform operations. The operations include receiving field seismic data that represents a subsurface, identifying features in the field seismic data using a machine learning model that was trained using at least one first synthetic seismic data set that includes one or more features and one or more labels of the features, and at least one second synthetic seismic data set, the first and second synthetic seismic data sets both generated based on a geological model, noise being injected into the second synthetic seismic data based on the geological model, and generating a model of the subsurface based at least in part on the features that were identified in the field seismic data using the machine learning model.

Embodiments of the disclosure also include a non-transitory, computer-readable medium storing instructions that, when executed by at least processor of a computing system, cause the computing system to perform operations. The operations include receiving field seismic data that represents a subsurface, identifying features in the field seismic data using a machine learning model that was trained using at least one first synthetic seismic data set that includes one or more features and one or more labels of the features, and at least one second synthetic seismic data set, the first and second synthetic seismic data sets both generated based on a geological model, noise being injected into the second synthetic seismic data based on the geological model, and generating a model of the subsurface based at least in part on the features that were identified in the field seismic data using the machine learning model.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a sequential view of a geological model, and synthetic and actual field seismic data, for training and implementing a machine learning model, according to an embodiment.

FIG. 5 illustrates a flowchart of a method for seismic interpretation, according to an embodiment.

FIG. 6 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

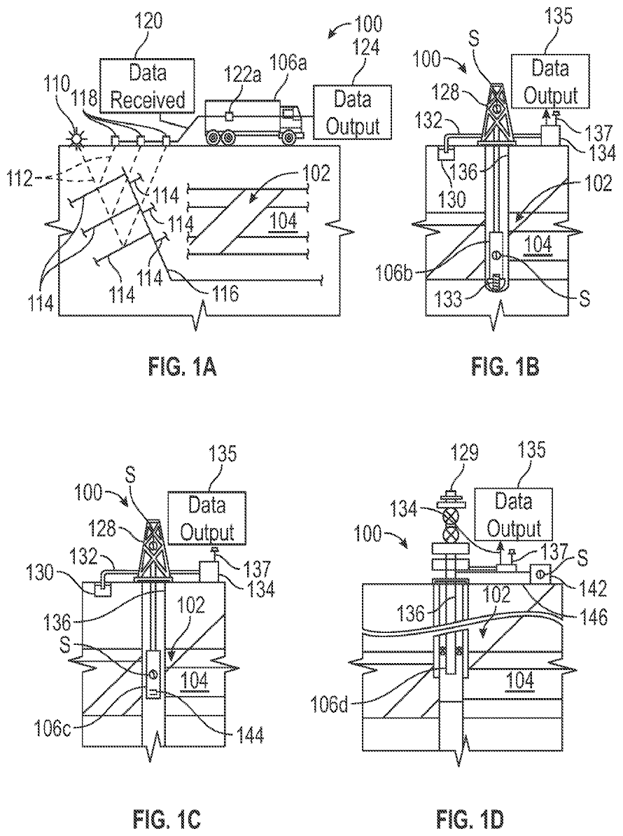

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

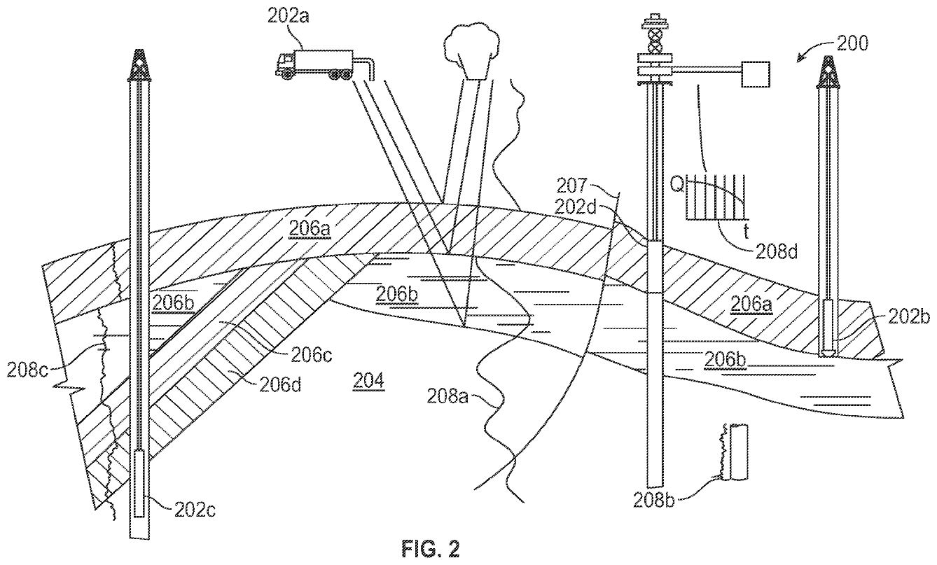

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

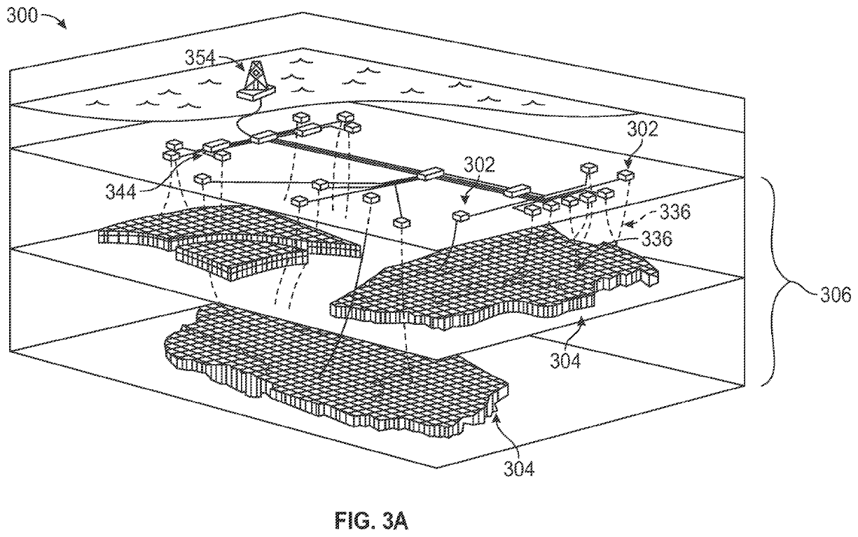

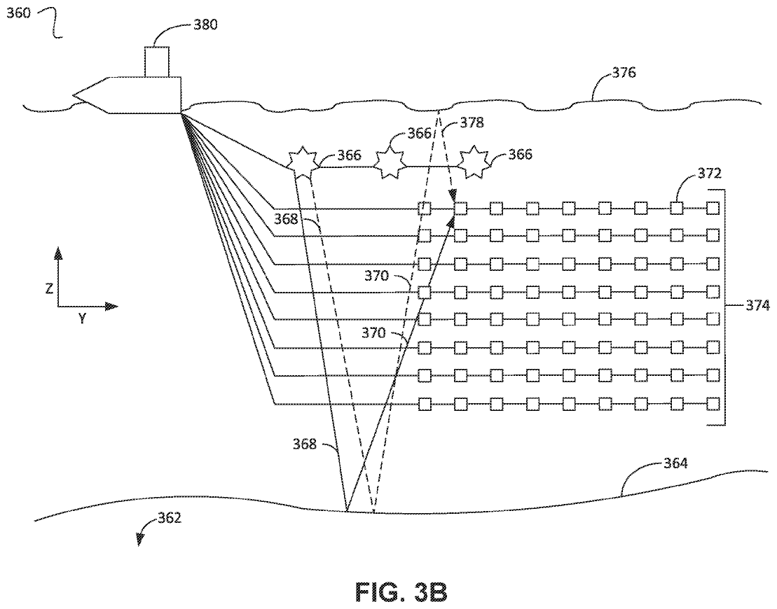

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Embodiments of the present disclosure include systems, computer-readable media, and methods that use simulated seismic reflections and geophysical artifacts from one-dimensional (1D) and three-dimensional (3D) synthetic seismic images to train a machine model to discern between geological seismic events and geophysical artifacts. Subsequently, the trained machine model is further trained to predict geological features in real seismic images through the process of transfer learning.

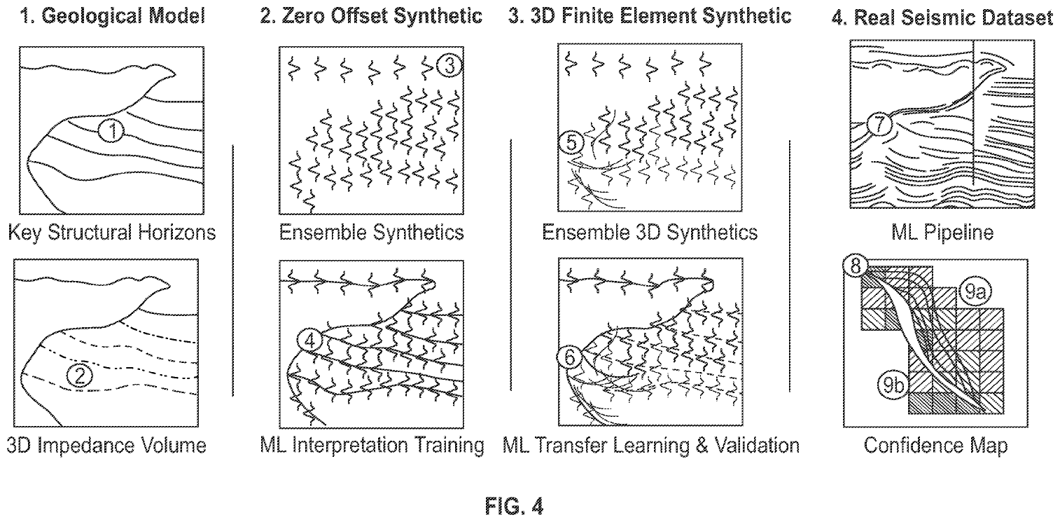

As shown in FIG. 4, a priori knowledge is used to construct (or otherwise obtain) geological models of the subsurface. Referring to the upper-left tile first, the models may include representations of geological faults and horizons 1, which in turn represent contacts or interfaces between geobodies of different seismic impedance characteristics 2. A 3D seismic impedance volume may be used to calculate ensembles of 1D (zero-offset) synthetic seismic images 3 convolved with different styles of commonly recognized seismic noise. Coefficients of the machine learning model are initially derived through the training process on the 1D synthetic seismic images to predict geological features like faults and horizons 4 in the presence of synthetically generated noise.

The machine learning model coefficients are further refined through the transfer learning process when the model is subsequently trained on 3D finite element (FE) synthetic seismic images that have different types of geophysical artifacts 5 related to geometric illumination that can obfuscate the reflective appearance of geological features and produce characteristic image textures. Through the transfer learning process the updated machine model is trained to recognize which seismic image features are related to both 1D and 3D geophysical artifacts and which image features are related to geological interpretations 6.

By way of brief explanation, in the 1D synthetic case, the seismogram is created by convolving a wavelet with a 1D reflection coefficient (RC) series defined by the geological model. Artificial noise is created by adding variations to the original RC series and/or through various phase and frequency adjustments to the convolved wavelet. In the 3D synthetic case, the seismogram is created by forward propagating wavefields into the geological model based on a given survey geometry. The wave propagation generates converted mode energy at interfaces and the waveforms may propagate away from geophones at the surface if there are strong lateral velocity gradients in the geological model. The simulated waveforms are 3D migrated and demonstrate wave propagation artifacts on stacked seismic sections.

In at least some embodiments, the transfer learning method may rely upon any number of seismic synthetic inputs in any geological environment, basin, geophysical noise depending upon the desired interpretation use on a real seismic image.

The machine learning model coefficients may be further refined through training labels generated by an expert human interpreter on a subset of seismic images from the real seismic dataset. The trained machine learning model may then predict geological interpretations 7 on seismic images in the presence of real geophysical artifacts and provides quantitative metrics on interpretation accuracy.

The method facilitates the interpretation of multitudes of seismic images in a timely fashion and reduces biases associated with human perception and interpretation on small subsets of data. The method may also include aggregating the ML-assisted interpretations to generate maps of geological features 8 and uncertainty attributes demonstrating areas of high 9a and low 9b confidence.

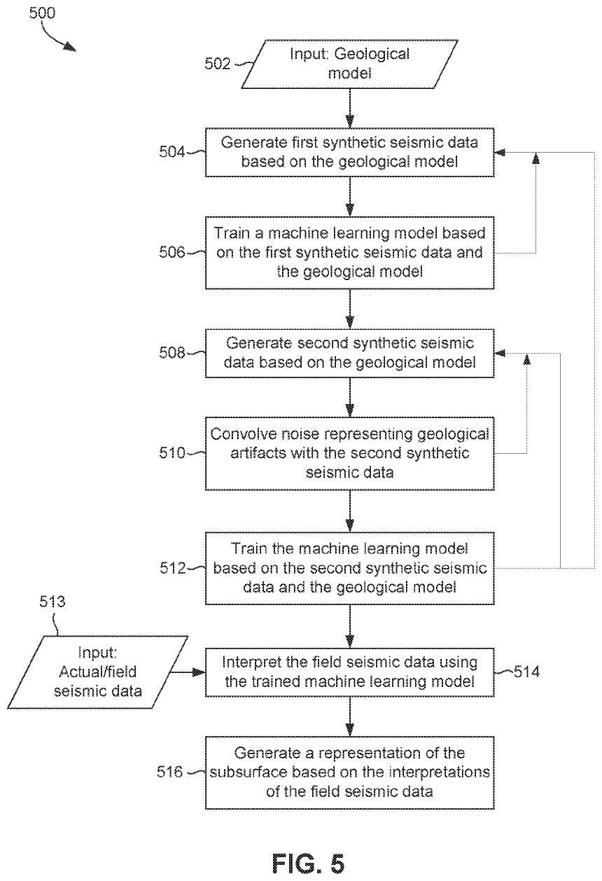

FIG. 5 illustrates a flowchart of a method 500 for seismic interpretation, according to an embodiment. The method 500 may include receiving a geological model, including representations of geological features, such as faults and horizons of a subsurface, as at 502. In some embodiments, several different geological models may be employed, e.g., taken from different wells, preserving different characteristics, etc. For purposes of description herein, a base case of a single geological model is considered as part of a loop, e.g., whereby the method 500 may complete one or more activities and then iterate back and complete those same activities using a different initial geological model. However, embodiments are envisaged that combine two or more geological models in a single loop.

First synthetic seismic data may be generated from the geological model, as at 504. For example, seismic data that would be expected based upon the structure of the geological model may be generated using the geological model and any one of various synthetic seismic data techniques. Initially, such seismic synthetic data may be generated in 1D, zero-offset (e.g., as a vertical seismic profile taken from a well). Different types of commonly recognized types of noise can be convolved with the first synthetic data to enhance the training of the machine learning model, e.g., as part of the generation of the first synthetic data or subsequent thereto.

The method 500 may then include training a machine learning model to identify features in the geological model, based on the first synthetic seismic data, as at 506. That is, the features of the geological model may be known, and thus the synthetic seismic data corresponding to these features may be labeled based on the features of the model. The pairs of labels and synthetic data may be employed as ground truths for training the geological model. For purposes of description herein, a base case of a single 1D synthetic data set is considered as part of a loop, e.g., whereby the method 500 may complete one or more activities and then iterate back and complete those same activities using different 1D synthetic data set(s). However, embodiments are envisaged that combine two or more 1D data sets in a single loop.

The method 500 may also include generating second synthetic data, in this example, synthetic data that is generated through forward propagating synthetic seismic wavefields in three dimensions, referred to herein as “three-dimensional synthetic data”, as at 508. The three-dimensional synthetic data may thus be based on the geological model. The three-dimensional synthetic data may be generated, for example, using finite-element (FE) synthetic generation techniques. For purposes of description herein, a base case of a single 3D synthetic (e.g., FE) data set is considered as part of a loop, e.g., whereby the method 500 may complete one or more activities and then iterate back and complete those same activities using different 1D synthetic data set(s). However, embodiments are envisaged that combine two or more 3D data sets in a single loop.

Various noise modes that are observed in seismic data collected in the field can be modeled. Interpreters may expect certain types of noise based on the characteristics of the signal. The noise may represent geophysical artifacts related to geometric illumination, for example. The effects of these types of noise that are commonly seen on such seismic signals can thus be convolved into the 3D synthetic seismic data, based on the characteristics of the geological model, as at 510. Such noise modes may include P-S mode conversion and/or azimuthal illumination, to name two examples. In other words, a noise function or model is built, based on the characteristics of different modes of noise that may be expected. The noise function/model generates noise based on the characteristics of the subsurface, as represented by the geological model. Thus, noise can be injected, representing geophysical artifacts related to geometric illumination, for example, into the second synthetic data. More particularly, the 3D effects of P-S mode conversion, azimuthal illumination, geometric focusing, etc., may be simulated through the propagating waveforms, and not through direct convolution, unlike the noise convolved into the first synthetic data. Additionally, synthetic noise may be added to the synthetic shot records or the stacked migrated image through convolution, similar to the introduction of noise in the first synthetic data.

Returning to the illustrated embodiment, the method 500 may then include again training the machine learning model to identify the features of the geological model, this time based on the second seismic data, e.g., the 3D synthetic seismic data that is convolved with the noise, as at 512. Thus, the machine learning model can be trained to accurately pick features in the presence of noise that often reduces confidence and/or accuracy in other machine learning models.

A “real” or field seismic data set may then be acquired at 513 and interpreted using the trained machine learning model at 514. One or more seismic images, velocity models, geological models, etc. may then be generated, representing the various characteristics of the subsurface, as at 516. This representation may be or permit the construction of a seismic image of the subsurface. The seismic image may be more efficiently produced than other seismic images, because it is generated by employing an embodiment of the present disclosure, through the training and implementing of a machine learning model that uses transfer learning. Further, this seismic image may be used in a variety of exploration, drilling, completion, or other oilfield operations. The seismic image may be employed to control such operations, including determining whether, where, and how to construct a well given the accurate understanding of the subsurface that is generated from the model discussed above. The machine learning model is implemented to reduce reliance on human subject matter experts to interpret many hundreds or thousands of images, which may be time and labor intensive. This, the present method implements a practical application of generating a more accurate representation of a subsurface domain from seismic data and doing so potentially more efficiently, which is useful in a variety of contexts for imaging and making decisions about operations in the oilfield.

Further, as indicated in FIG. 5 and noted above, various loops may be individually applied or combined/nested, as shown. For example, after completing the training at 512, the method 500 may return to 508 and generate second synthetic data based on another geological model or based on the same model but using different parameters/techniques. Similarly, the method 500 may (again) generate second synthetic seismic data after convolving the noise at 510, e.g., using different geological models, convolved with different noise, using different parameters/techniques to generate the second seismic data, or combinations thereof. The method 500 may also or instead loop back from 512 and generate additional first synthetic seismic data based on another geological model and/or using different synthetic seismic data generate techniques/parameters. The method 500 may also or instead include a loop between 506 and 504, in which the machine learning model is repeatedly trained at 506 using different first synthetic seismic data, e.g., generated using different geological models and/or different synthetic seismic data generate techniques and/or parameters. Any combination of these various loops and/or others may be employed.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

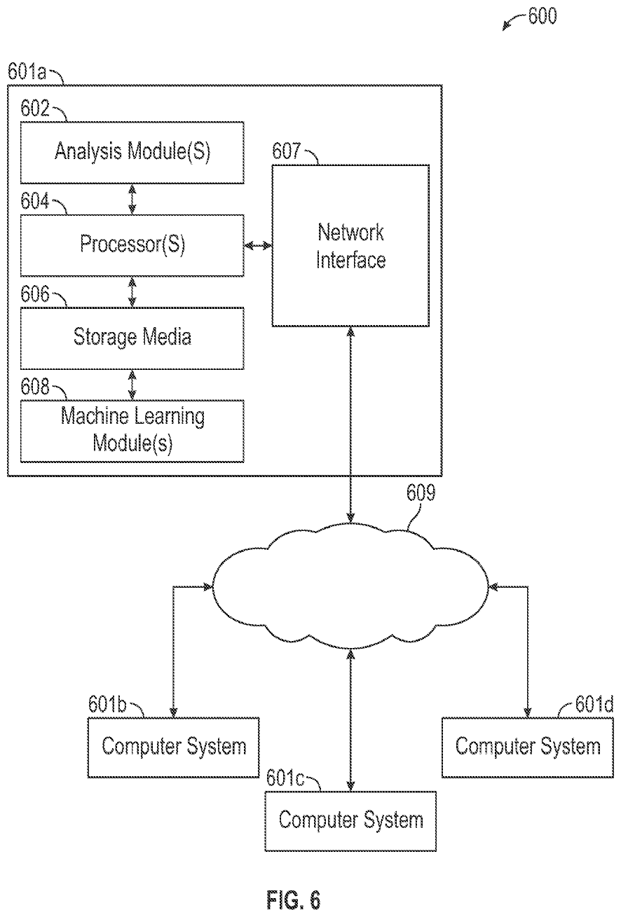

In some embodiments, any of the methods of the present disclosure may be executed using a system, such as a computing system. FIG. 6 illustrates an example of such a computing system 600, in accordance with some embodiments. The computing system 600 may include a computer or computer system 601a, which may be an individual computer system 601a or an arrangement of distributed computer systems. The computer system 601a includes one or more analysis module(s) 602 configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601a to communicate over a data network 609 with one or more additional computer systems and/or computing systems, such as 601b, 601c, and/or 601d (note that computer systems 601b, 601c and/or 601d may or may not share the same architecture as computer system 601a, and may be located in different physical locations, e.g., computer systems 601a and 601b may be located in a processing facility, while in communication with one or more computer systems such as 601c and/or 601d that are located in one or more data centers, and/or located in varying countries on different continents).

A processor can include a microprocessor, microcontroller, processor module or subsystem, programmable integrated circuit, programmable gate array, or another control or computing device.

The storage media 606 can be implemented as one or more computer-readable or machine-readable storage media. Note that while in the example embodiment of FIG. 6 storage media 606 is depicted as within computer system 601a, in some embodiments, storage media 606 may be distributed within and/or across multiple internal and/or external enclosures of computing system 601a and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is(are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 600 contains one or more machine learning module(s) 608. In the example of computing system 600, computer system 601a includes the machine learning module 608. In some embodiments, a single machine learning module may be used to perform some or all aspects of one or more embodiments of the methods. In alternate embodiments, a plurality of machine learning modules may be used to perform some or all aspects of methods.

It should be appreciated that computing system 600 is only one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving field seismic data that represents a subsurface;
identifying features in the field seismic data using a machine learning model that was trained using at least one first synthetic seismic data set that includes one or more features and one or more labels of the features, and at least one second synthetic seismic data set, the first and second synthetic seismic data sets both generated based on a geological model, wherein noise is injected into the second synthetic seismic data based on the geological model; and
generating a model of the subsurface based at least in part on the features that were identified in the field seismic data using the machine learning model.

2. The method of claim 1, further comprising:
obtaining the geological model including the one or more features and the labels of the features;
generating the first synthetic seismic data based on the geological model;
training the machine learning model to identify the one or more features based on the first synthetic data and the labels;
generating the second synthetic seismic data based on the geological model;
injecting the noise into the second synthetic seismic data based on the geological model, the noise representing one or more geological artifacts; and
training the machine learning model to identify the one or more features based on the second synthetic data, the labels, and the noise.

3. The method of claim 1, wherein the first synthetic seismic data comprises one-dimensional seismic data.

4. The method of claim 3, wherein the first synthetic seismic data comprises zero-offset seismic data.

5. The method of claim 1, wherein the second synthetic seismic data comprises three-dimensional seismic data.

6. The method of claim 5, wherein the three-dimensional seismic data comprises finite element seismic data.

7. The method of claim 1, wherein the noise comprises noise generated by P-S mode conversion, azimuthal illumination, or both.

8. A computing system, comprising:
one or more processors; and
a memory including one or more non-transitory, computer-readable media storing instructions that, when executed by at least one of the one or more processors, cause the computing system to perform operations, the operations comprising:
receiving field seismic data that represents a subsurface;
identifying features in the field seismic data using a machine learning model that was trained using at least one first synthetic seismic data set that includes one or more features and one or more labels of the features, and at least one second synthetic seismic data set, the first and second synthetic data sets both generated based on a geological model, wherein noise is injected into the second synthetic seismic data based on the geological model; and
generating a model of the subsurface based at least in part on the features that were identified in the field seismic data using the machine learning model.

9. The computing system of claim 8, wherein the operations further comprise:
obtaining the geological model including the one or more features and the labels of the features;
generating the first synthetic seismic data based on the geological model;
training the machine learning model to identify the one or more features based on the first synthetic data and the labels;
generating the second synthetic seismic data based on the geological model;
injecting the noise into the second synthetic seismic data based on the geological model, the noise representing one or more geological artifacts; and
training the machine learning model to identify the one or more features based on the second synthetic data, the labels, and the noise.

10. The computing system of claim 8, wherein the first synthetic seismic data comprises one-dimensional seismic data.

11. The computing system of claim 10, wherein the first synthetic seismic data comprises zero-offset seismic data.

12. The computing system of claim 8, wherein the second synthetic seismic data comprises three-dimensional seismic data.

13. The computing system of claim 12, wherein the three-dimensional seismic data comprises finite element seismic data.

14. The computing system of claim 8, wherein the noise comprises noise generated by P-S mode conversion, azimuthal illumination, or both.

15. A non-transitory, computer-readable medium storing instructions that, when executed by at least one processor of a computing system, cause the computing system to perform operations, the operations comprising:
receiving field seismic data that represents a subsurface;
identifying features in the field seismic data using a machine learning model that was trained using at least one first synthetic seismic data set that includes one or more features and one or more labels of the features, and at least one second synthetic seismic data set, the first and second synthetic seismic data sets both generated based on a geological model, wherein noise is injected into the second synthetic seismic data based on the geological model; and
generating a model of the subsurface based at least in part on the features that were identified in the field seismic data using the machine learning model.

16. The medium of claim 15, wherein the operations further comprise:
obtaining the geological model including the one or more features and the labels of the features;
generating the first synthetic seismic data based on the geological model;
training the machine learning model to identify the one or more features based on the first synthetic data and the labels;
generating the second synthetic seismic data based on the geological model;
injecting the noise into the second synthetic seismic data based on the geological model, the noise representing one or more geological artifacts; and
training the machine learning model to identify the one or more features based on the second synthetic data, the labels, and the noise.

17. The medium of claim 15, wherein the first synthetic seismic data comprises one-dimensional seismic data.

18. The medium of claim 17, wherein the first synthetic seismic data comprises zero-offset seismic data.

19. The medium of claim 15, wherein the second synthetic seismic data comprises three-dimensional seismic data, and wherein the three-dimensional seismic data comprises finite element seismic data.

20. The computing system of claim 15, wherein the noise comprises noise generated by P-S mode conversion, azimuthal illumination, or both.
